(19) United States
(12) Patent Application Publication
(10) Pub. No.: US 2019/0157640 A1
(43) Pub. Date: May 23, 2019

(54) BATTERY ASSEMBLY ENDPLATE AND BATTERY ASSEMBLY SECURING METHOD USING AN ENDPLATE

(71) Applicant: Ford Global Technologies, LLC, Dearborn, MI (US)

(72) Inventors: Eid Farha, Ypsilanti, MI (US); Hari Krishna Addanki, Novi, MI (US); Keith Kearney, Grosse Ile, MI (US); Jeffrey Haag, Dearborn, MI (US)

(21) Appl. No.: 15/819,578

(22) Filed: Nov. 21, 2017

(51) Int. Cl. H01M 2/10; H01M 10/613; H01M 10/625; H01M 10/6555; H01M 10/6557

(52) U.S. Cl. CPC H01M 2/1077; H01M 10/613; H01M 2220/20; H01M 10/6555; H01M 10/6557; H01M 10/625

(57) ABSTRACT

An exemplary battery assembly includes, among other things, a first array of battery cells distributed along a first axis, and a second array of battery cells distributed along a second axis laterally spaced from the second axis. A thermal exchange plate is disposed between the first and second arrays. An endplate spans across at least a portion of axially facing end of both the first and second array. An exemplary securing method includes, among other things, positioning a first array of battery cells adjacent a first side of a thermal exchange plate, and a second array of battery cells adjacent an opposite, second side of the thermal exchange plate. The method includes securing the first and second arrays with an endplate spanning across axially facing ends of the both the first and second arrays.

### TECHNICAL FIELD

This disclosure relates generally to an endplate of a battery array assembly within a traction battery and, more particularly, to an endplate that secures more than one array of battery cells.

### BACKGROUND

Generally, electrified vehicles differ from conventional motor vehicles because electrified vehicles are selectively driven using one or more battery-powered electric machines. Conventional motor vehicles, in contrast to electrified vehicles, are driven exclusively with an internal combustion engine. Electrified vehicles may use electric machines instead of, or in addition to, the internal combustion engine.

Example electrified vehicles include hybrid electric vehicles (HEVs), plug-in hybrid electric vehicles (PHEVs), fuel cell vehicles, and battery electric vehicles (BEVs). A powertrain for an electrified vehicle can include a high-voltage battery pack having battery cells that store electric power for powering the electric machines and other electrical loads of the electrified vehicle.

Some battery packs include more than one array of battery cells. Each of the arrays is sandwiched axially between a respective pair of endplates. Thus, to secure two arrays, four separate endplates can be required.

### SUMMARY

A battery assembly according to an exemplary aspect of the present disclosure includes, among other things, a first array of battery cells distributed along a first axis, and a second array of battery cells distributed along a second axis laterally spaced from the second axis. A thermal exchange plate is disposed between the first and second arrays. An endplate spans across axially facing ends of both the first and second arrays.

In a further non-limiting embodiment of the foregoing assembly, the endplate is a common endplate.

In a further non-limiting embodiment of any of the foregoing assemblies, the endplate is a first endplate and the axially facing ends that face in a first axial direction. The assembly further includes a second endplate spanning across axially facing ends of both the first and second arrays that face in an opposite, second axial direction.

In a further non-limiting embodiment of any of the foregoing assemblies, a geometry of the first endplate mimics a geometry of the second endplate.

In a further non-limiting embodiment of any of the foregoing assemblies, the endplate is secured directly to an axially facing side of the thermal exchange plate.

In a further non-limiting embodiment of any of the foregoing assemblies, the endplate is biased against the axially facing ends of both the first and second arrays when the endplate is secured directly to the axially facing side of the thermal exchange plate.

In a further non-limiting embodiment of any of the foregoing assemblies, the endplate provides at least one aperture to move a coolant to the thermal exchange plate, from the thermal exchange plate, or both.

In a further non-limiting embodiment of any of the foregoing assemblies, the first and second arrays are side-oriented arrays.

In a further non-limiting embodiment of any of the foregoing assemblies, the battery cells in the first and second arrays include respective bottom faces that interface directly with the thermal exchange plate. The battery cells within the first and second arrays further including a plurality of top faces opposite the bottom faces.

A further non-limiting embodiment of any of the foregoing assemblies includes terminals of the battery cells in the first and second arrays. The terminals extend through respective faces of the battery cells opposite the thermal exchange plate.

A securing method according to an exemplary aspect of the present disclosure includes, among other things, positioning a first array of battery cells adjacent a first side of a thermal exchange plate, and a second array of battery cells adjacent an opposite, second side of the thermal exchange plate. The method includes securing the first and second arrays with an endplate spanning across axially facing ends of the both the first and second arrays.

In a further non-limiting embodiment of the foregoing method, the endplate is a common endplate.

In a further non-limiting embodiment of any of the foregoing methods, the endplate is a first endplate. The method further includes sandwiching the first and second arrays axially between the first endplate and a second endplate that extends across axially facing ends of both the first and second arrays.

In a further non-limiting embodiment of any of the foregoing methods, a geometry of the first endplate mimics a geometry of the second endplate.

A further non-limiting embodiment of any of the foregoing methods includes securing the endplate directly to an axially facing side of the thermal exchange plate.

A further non-limiting embodiment of any of the foregoing methods includes biasing the endplate against the axially facing ends of both the first and second arrays when securing the endplate directly to the thermal exchange plate.

In a further non-limiting embodiment of any of the foregoing methods, the first and second arrays are side oriented arrays.

A further non-limiting embodiment of any of the foregoing methods includes communicating thermal energy through respective bottom faces of the battery cells within the first and second arrays. The method further includes communicating electrical power to and from the battery cells through terminals disposed within another surface of the battery cells that is opposite the bottom surface.

A further non-limiting embodiment of any of the foregoing methods includes communicating a fluid to the thermal exchange plate, from the thermal exchange plate, or both through an aperture provided within the thermal exchange plate.

A further non-limiting embodiment of any of the foregoing methods includes, after the securing, repositioning the first and second arrays, and the thermal exchange plate, by interfacing with a handle member of the endplate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an electrified vehicle.

FIG. 2 illustrates a partially expanded view of a battery assembly from a battery pack of the powertrain of FIG. 2.

FIG. 3 illustrates a perspective view of the battery assembly and a selected portion of an enclosure from the powertrain of FIG. 1.

FIG. 4 illustrates a section view taken at Line 4-4 in FIG. 2.

FIG. 5 illustrates a battery cell from the battery assembly of FIG. 2.

FIG. 6 illustrates a flow of an example array securing method using an endplate.

### DETAILED DESCRIPTION

This disclosure details an endplate for use within a battery pack of an electrified vehicle.

The endplate is disposed adjacent a first array of battery cells, and additionally disposed against a separate, second array of battery cells. Utilizing a common endplate can, among other things, reduce an overall complexity of the battery pack, as well as provide various other benefits as will be discussed below.

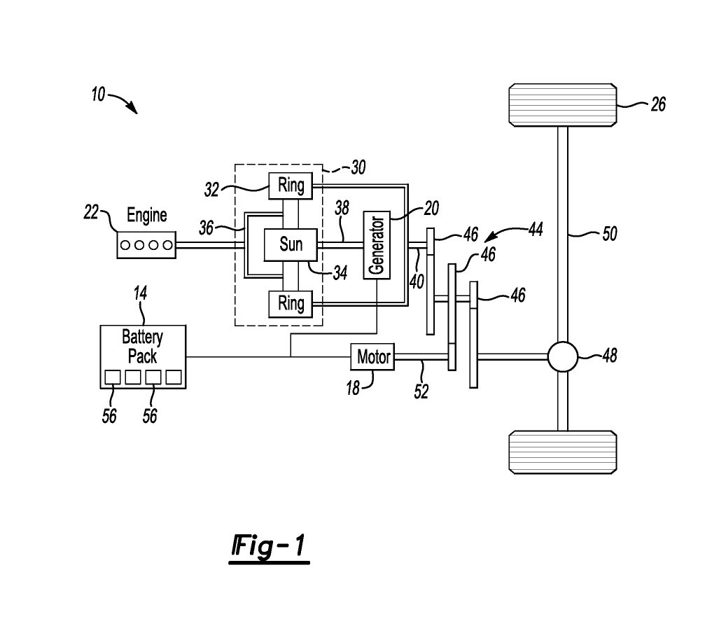

FIG. 1 schematically illustrates a powertrain 10 for an electrified vehicle, which is a hybrid electric vehicle (HEV) in this example. Although depicted as an HEV, it should be understood that the concepts described herein are not limited to HEVs and could extend to other types of electrified vehicle, including, but not limited to, plug-in hybrid electric vehicles (PHEVs), battery electric vehicles (BEVs), fuel cell vehicles, etc.

The powertrain 10 includes a battery pack 14, a motor 18, a generator 20, and an internal combustion engine 22. The motor 18 and generator 20 are types of electric machines. The motor 18 and generator 20 may be separate or may have the form of a combined motor-generator.

In this embodiment, the powertrain 10 is a power-split powertrain system that employs a first drive system and a second drive system. The first and second drive systems generate torque to drive one or more sets of vehicle drive wheels 26 of the electrified vehicle. The first drive system includes a combination of the engine 22 and the generator 20. The second drive system includes at least the motor 18, the generator 20, and the battery pack 14. The motor 18 and the generator 20 are portions of an electric drive system of the powertrain 10.

The engine 22, which is an internal combustion engine in this example, and the generator 20 may be connected through a power transfer unit 30, such as a planetary gear set. Of course, other types of power transfer units, including other gear sets and transmissions, could be used to connect the engine 22 to the generator 20. In one non-limiting embodiment, the power transfer unit 30 is a planetary gear set that includes a ring gear 32, a sun gear 34, and a carrier assembly 36.

The generator 20 can be driven by engine 22 through the power transfer unit 30 to convert kinetic energy to electrical energy. The generator 20 can alternatively function as a motor to convert electrical energy into kinetic energy, thereby outputting torque to a shaft 38 connected to the power transfer unit 30. Because the generator 20 is operatively connected to the engine 22, the speed of the engine 22 can be controlled by the generator 20.

The ring gear 32 of the power transfer unit 30 can be connected to a shaft 40, which is connected to vehicle drive wheels 26 through a second power transfer unit 44. The second power transfer unit 44 may include a gear set having a plurality of gears 46. Other power transfer units may also be suitable.

The gears 46 transfer torque from the engine 22 to a differential 48 to ultimately provide traction to the vehicle drive wheels 26. The differential 48 may include a plurality of gears that enable the transfer of torque to the vehicle drive wheels 26. In this example, the second power transfer unit 44 is mechanically coupled to an axle 50 through the differential 48 to distribute torque to the vehicle drive wheels 26.

The motor 18 can also be employed to drive the vehicle drive wheels 26 by outputting torque to a shaft 52 that is also connected to the second power transfer unit 44. In one embodiment, the motor 18 and the generator 20 cooperate as part of a regenerative braking system in which both the motor 18 and the generator 20 can be employed as motors to output torque. For example, the motor 18 and the generator 20 can each output electrical power to the battery pack 14.

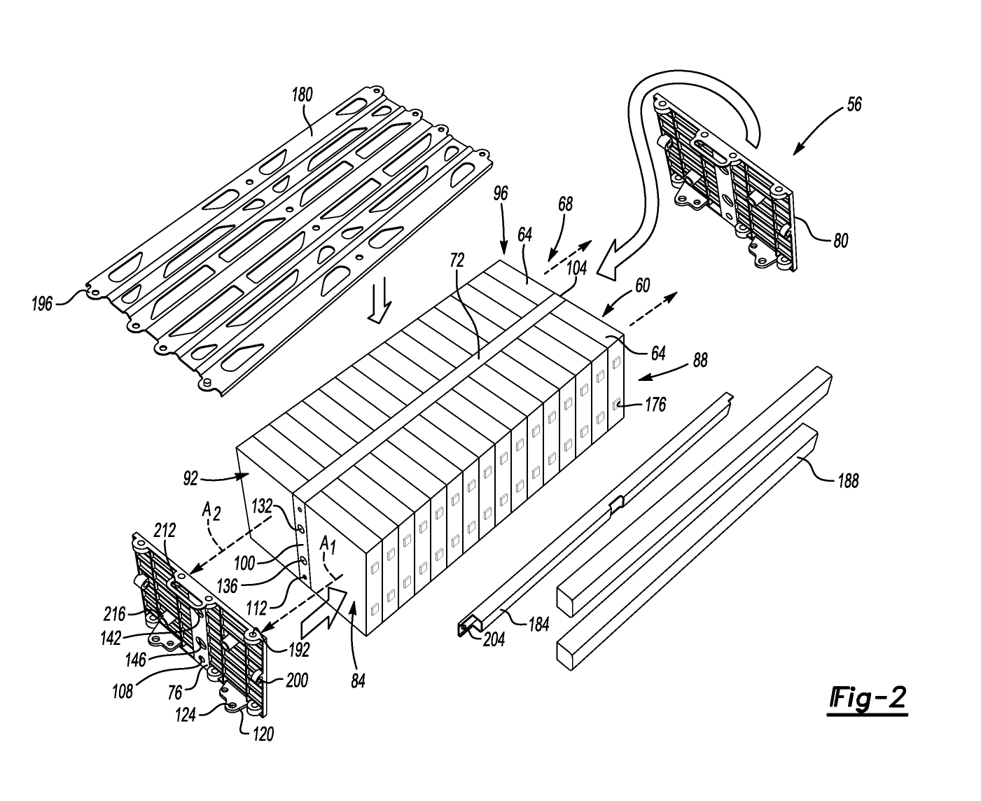

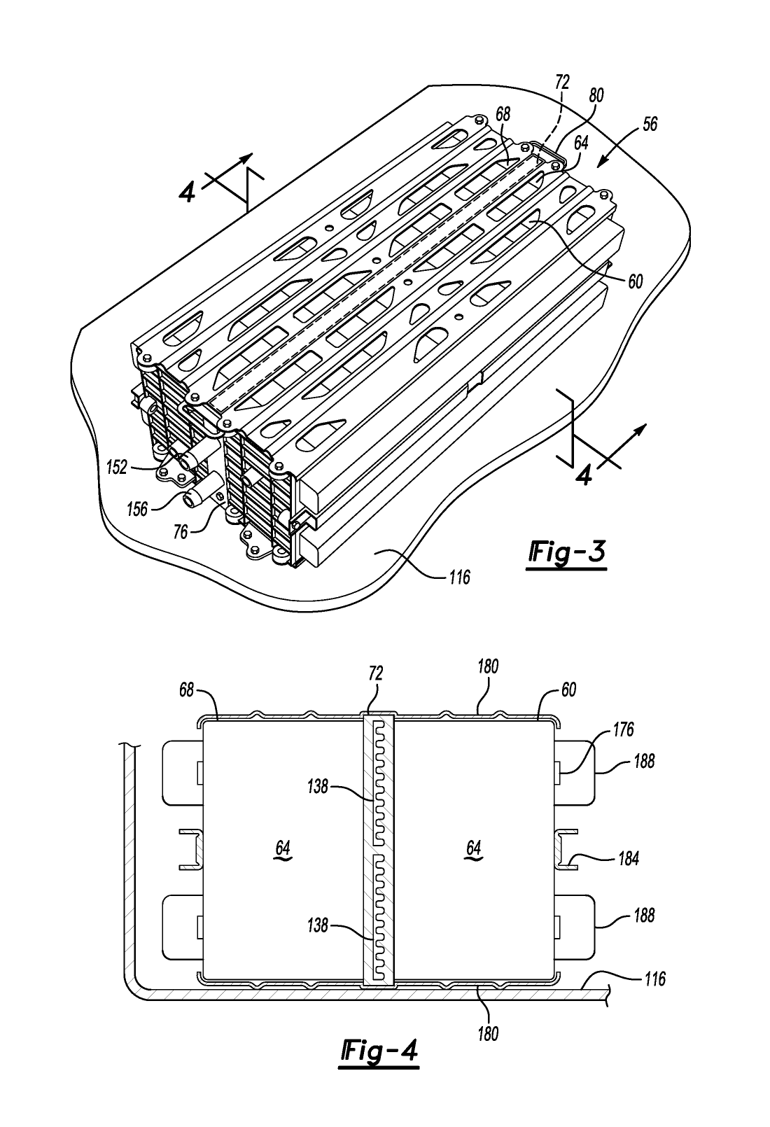

Referring now to FIGS. 2-4, the battery pack 14 in an exemplary embodiment of the present disclosure, includes a battery assembly 56 having a first array 60 of battery cells 64, a second array 68 of battery cells 64, a thermal exchange plate 72, a first endplate 76, and a second endplate 80. The battery assembly 56 can be one of several battery assemblies incorporated into the battery pack 14.

The battery cells 64 of the first array 60 are distributed along a first axis A₁. The battery cells 64 of the second array 68 are distributed along a second axis A₂. The first axis A₁ is laterally spaced from the second axis A₂. The thermal exchange plate 72 is disposed between the first array 60 and the second array 68.

The first array 60 extends from a first axial end 84 and an opposite, second axial end 88. The second array 68 extends from a first axial end 92 to a second axial end 96. The ends 84, 88, 92, and 96 are axial ends because the ends 84, 88, 92, 96 are the endmost portions of the array 60 along the axis A₁, and the array 68 along the axis A₂. The first axial end 84 of the first array 60 is generally axially aligned with the first axial end 92 of the second array 68. The second axial end 88 of the first array 60 is generally axially aligned with the second axial end 96 of the second array 68.

When the battery pack 14 is assembled, the first endplate 76 spans across at least a portion of the first axial end 84 of the first array 60, and across at least a portion of the first axial end 92 of the second array 68. Also, the second endplate 80 spans across at least a portion of the second axial end 88 of the first array 60, and at least a portion of the second axial end 96 of the second array 68. Thus, the first endplate 76 is common endplate that spans across both the first axial ends 84 and 92, and the second endplate 80 is a common endplate that spans across both the second axial ends 88 and 96.

Notably, a geometry of the first endplate 76 mimics a geometry of the second endplate 80. Thus, common tooling can be used to produce both the first endplate 78 and the second endplate 80.

The endplates 76 and 80 are secured, in this exemplary embodiment, to the thermal exchange plate 72. In particular, the first endplate 76 is secured to a first axially facing side 100 of the thermal exchange plate 72, and the second endplate 80 is secured to an opposite, second axially facing side 104 of the thermal exchange plate 72.

Mechanical fasteners, such as threaded bolts, can extend through apertures 108 in the first endplate 76 to engage threaded apertures 112 opening to the first axially facing side 100 of the thermal exchange plate 72. Although described as mechanical fasteners, other connection techniques could be utilized including, for example, welding the first endplate 76 to the thermal exchange plate 72.

The second endplate 80 can be secured to the second axially facing side 100 of the thermal exchange plate 72 in a manner similar to the connection strategy utilized in connection with the first endplate 76.

Notably, the securing of the endplates 76 and 80 to the thermal exchange plate 72 can pull the endplates 76 and 80 closer axially together relative to each other, which can bias the endplates 76 and 80 axially toward the arrays 60 and 68. The biasing of the endplates 76 and 80 against the axially facing ends of the arrays 60 and 68 can sandwich and compress the battery cells 64 axially within the arrays 60 and 68.

The battery pack 14 can include an enclosure having a tray 116. A lid (not shown) of the enclosure can be secured to the tray 116 to provide an open area that receives the arrays 60 and 68 and the remaining components shown in FIG. 2. The tray 116 can be a polymer or a polymer-based material. The tray 116 could instead be a metal, a metal-alloy, or another material.

The first endplate 76 includes flanges 120 having apertures 124. A mechanical fastener, such as a threaded connector, can be inserted through the aperture 124 and secured to the tray 116 to secure the first endplate 76 within the open area of the enclosure. A similar connection strategy could be utilized to secure the second endplate 80 to the tray 116.

Charging and discharging of the battery cells 64 can generate thermal energy. The thermal exchange plate 72 can be utilized to remove thermal energy from the battery cells 64. In another example, the thermal exchange plate 72 could be utilized to add thermal energy to the battery cells 64.

The thermal exchange plate 72, in this exemplary embodiment, includes an inlet 132 and an outlet 136. Coolant, such as a fluid coolant, can be moved by, for example, a pump from a coolant supply through the inlet 132 to the thermal exchange plate 72. The coolant circulates through channels 138 established within the thermal exchange plate 72. Within the channels 138, the coolant takes on thermal energy from the battery cells 64. The coolant is then communicated through the outlet 136 and moved through, for example, a heat exchanger to remove thermal energy from the coolant. The coolant can then be recirculated back to the fluid supply.

The first endplate 76 includes an aperture 142 aligned generally with the inlet 132 to the thermal exchange plate 72. The first endplate 76 additionally includes an aperture 146 generally aligned with the outlet 136 from the thermal exchange plate 72. When assembled, an inlet conduit 152 can extend through the aperture 142 to convey coolant to the inlet 132. An outlet conduit 156 can extend through the aperture 146 to convey coolant from the outlet 136 of the thermal exchange plate 72. In this example, the conduits 152 and 156 are separate from the first endplate 76. In another example, the first endplate 76 is formed to include at least some portion of the conduit 152, the conduit 156, or both.

As the geometry of the second endplate 80 mimics the geometry of the first endplate 76, the second endplate 80 includes apertures corresponding to the apertures 142 and 146. However, because in the exemplary embodiment, coolant moves to and from the thermal exchange plate 72 only through the first axial end 100 of the thermal exchange plate 72, the apertures in the second endplate 80 are not utilized as opening to permit coolant flow.

In the exemplary embodiment, the inlet 132 and the outlet 136 are on the first axially facing side 100 of the thermal exchange plate 72. In another exemplary embodiment the inlet, the outlet, or another inlet or outlet could open to the second axially facing side 104 of the thermal exchange plate 72. In such an example, the apertures within the second endplate 80 could be utilized to provide a coolant communication path to, or from, the thermal exchange plate 72.

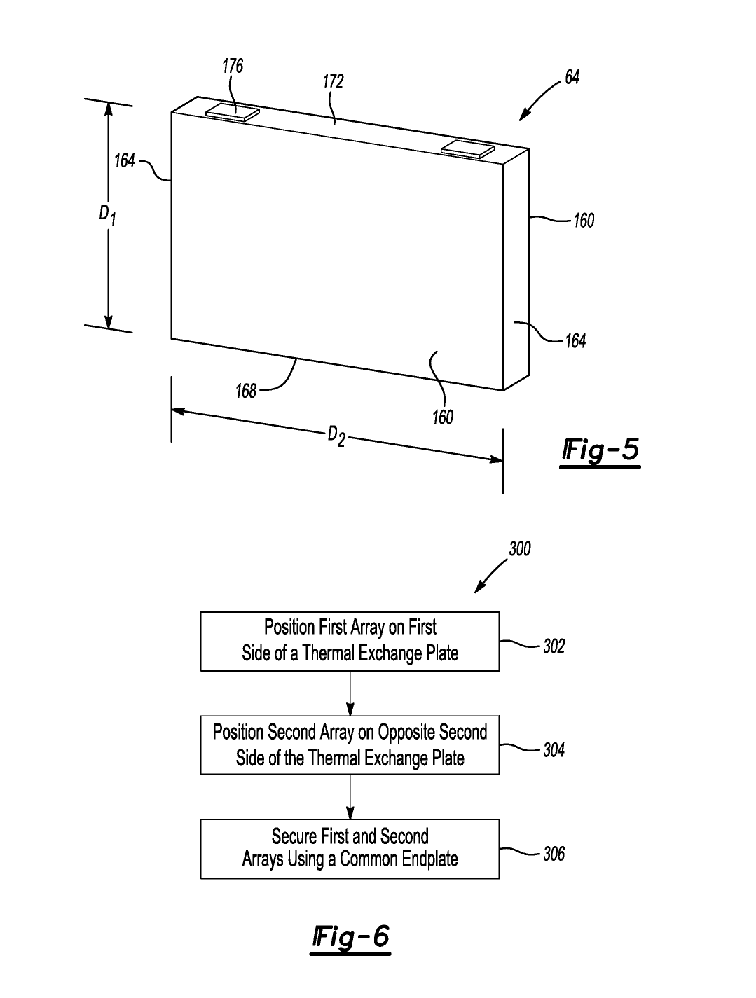

Referring now to FIG. 5 with continuing reference to FIGS. 2-4, the battery cells 64 include, in this example, axial faces 160, side faces 164, a bottom face 168, and a top face 172. Terminals 176 extend through the top face 172. The terminals 176 are utilized to convey electrical energy to and from the battery cell 64.

Generally, the bottom face 168 is a side of the battery cell 64 facing away from the top face 172. The top face 172 is, for purposes of this embodiment, considered the top face 172 because of the terminals 176 extending through the top face 172.

The side faces 164 of the battery cells 64 extend a distance D₁. The top face 172 and the bottom face 168 extend a distance D₂, which is greater than the distance D₁.

A surface area of the bottom face 168 is greater than a surface area of one of the side faces 164, as can be appreciated. In this example, the thermal exchange plate 72 is disposed adjacent the bottom faces 168 of the battery cells 64. The greater surface area of the bottom faces 168 can facilitate transferring thermal energy between the thermal exchange plate 72 and the battery cells 64.

The battery cells 64 of the exemplary embodiment are prismatic battery cells. In other examples, the battery cells 64 could be pouch cells.

The exemplary arrays 60 and 68 are considered side-oriented arrays. This is because the terminals 176 of the battery cells 64 face laterally outward within the battery pack 14. Side oriented arrays are different than standard-oriented arrays. The terminals of the batteries in standard oriented arrays would face upwardly within a battery pack. In another exemplary embodiment, the arrays 60 and 68 secured by the first endplate 76 and the second endplate 80 are standard-oriented arrays.

The first and second arrays 60 and 68 can be considered side oriented arrays additionally because they are disposed upon one of the side faces 164, rather than the bottom face 168. That is, the battery cells 64, which within the battery assemblies 56, are oriented on a side having a dimension D₁, which is smaller than the dimension D₂. When positioned within the battery pack 14, the arrays 60 and 68 are larger in a vertical direction than in a horizontal direction.

The side oriented configuration of the arrays can allow the battery pack 14 to be efficiently packaged into vehicle space that has sufficient vertical room, but may be limited in a cross-car direction. Vertical and horizontal, for purposes of this disclosure, refers to the general orientation of a vehicle having the battery pack 14 when the vehicle is parked or ordinarily operated, and with reference to ground.

The battery pack 14 additionally includes side plates 180, tension members 184, and bus bar assemblies 188. The first endplate 76 can include apertures 192 corresponding to apertures 196 in the side plates 180. A mechanical fastener can extend through the aperture 196 and the aperture 192 to secure the side plates 180 to the battery pack 14.

The tensioning member 184 extends axially from the first endplate 76 to the second endplate 80 and can be secured to the first endplate 76 and the second endplate 80. An aperture 200 within the first endplate 76 can be used in connection with an aperture 204 in the tensioning member 184. A threaded connector, for example, can extend through the aperture 200 and the aperture 204 to connect the tensioning member 184 to the first endplate 76.

The battery pack 14 may be compressed axially when securing the tensioning member 184 to the first endplate 76 and the second endplate 80. The compression can then be released, but the tensioning member 184, when secured, holds the position of the first endplate 76 and the second endplate 80 to maintain the battery cells 64 in an axially compressed state sandwiched between the first endplate 76 and the second endplate 80.

The tensioning member 184 could be a low gauge steel material. In some examples, the tensioning member 184 is a belt that could, for example, extend circumferentially about a perimeter of the battery assembly 56.

The bus bars 82 extend axially along the battery cells 64 and interface with the terminals 176. Electrical power can move between the bus bars 188 and the terminals 176 as the battery cells 64 are charged and discharged.

The first endplate 76 includes, in this example, a handle member 212. The handle member 212 can be a continuous and monolithic portion of the first endplate 76. The handle member 212 can be engaged with a, for example, hook structure of a lift assist. Engaging the handle member 212 can facilitate manipulating and repositioning the battery pack 14 during assembly.

Another feature of the first endplate 76 can include a boss 216 for connecting a sense lead to the battery assembly 56.

Referring now to FIG. 6, a securing method 300 according to an exemplary embodiment of the present disclosure begins at a step 302. The step 302 includes positioning a first array of battery cells adjacent a first side of a thermal exchange plate. Next, at a step 304, a second array of battery cells is positioned adjacent an opposite, second side of the thermal exchange plate. At a step 306, the first and second arrays are secured with an endplate spanning across axially facing ends of the both the first and second arrays. The endplate is a common endplate.

Features of the disclosed examples, include an endplate that can be used to secure axially ends of arrays of battery cells. An endplate having the same geometry can be used to secure opposing axial ends of the arrays. The endplates can be secured to opposing axial ends of a thermal exchange plate. The endplates can provide access to coolant ports of the endplates. Using one endplate design can, among other things, reduce part and build complexity.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery assembly, comprising:
a first array of battery cells distributed along a first axis;
a second array of battery cells distributed along a second axis laterally spaced from the second axis;
a thermal exchange plate disposed between the first and second arrays; and
an endplate spanning across at least a portion of an axially facing end of both the first and second array.

2. The battery assembly of claim 1, wherein the endplate is a common endplate.

3. The battery assembly of claim 1, wherein the endplate is a first endplate and the axially facing ends that face in a first axial direction, and further comprising a second endplate spanning across axially facing ends of both the first and second arrays that face in an opposite, second axial direction.

4. The battery assembly of claim 3, wherein a geometry of the first endplate mimics a geometry of the first endplate.

5. The battery assembly of claim 1, wherein the endplate is secured directly to an axially facing side of the thermal exchange plate.

6. The battery assembly of claim 5, wherein the endplate is biased against the axially facing ends of both the first and second arrays when the endplate is secured directly to the axially facing side of the thermal exchange plate.

7. The battery assembly of claim 1, wherein the endplate provides at least one aperture to move a coolant to the thermal exchange plate, from the thermal exchange plate, or both.

8. The battery assembly of claim 1, wherein the first and second arrays are side-oriented arrays.

9. The battery assembly of claim 8, wherein the battery cells in the first and second arrays include respective bottom faces that interface directly with the thermal exchange plate, the battery cells within the first and second arrays further including a plurality of top faces opposite the bottom faces.

10. The battery assembly of claim 8, further comprising terminals of the battery cells in the first and second arrays, the terminals extend through respective faces of the battery cells opposite the thermal exchange plate.

11. A securing method, comprising:
positioning a first array of battery cells adjacent a first side of a thermal exchange plate, and a second array of battery cells adjacent an opposite, second side of the thermal exchange plate; and
securing the first and second arrays with an endplate spanning across axially facing ends of the both the first and second arrays.

12. The securing method of claim 11, wherein the endplate is a common endplate.

13. The securing method of claim 11, wherein the endplate is a first endplate and further comprising sandwiching the first and second arrays axially between the first endplate and a second endplate that extends across axially facing ends of both the first and second arrays.

14. The securing method of claim 13, wherein a geometry of the first endplate mimics a geometry of the second endplate.

15. The securing method of claim 11, further comprising securing the endplate directly to an axially facing side of the thermal exchange plate.

16. The securing method of claim 15, further comprising biasing the endplate against the axially facing ends of both the first and second arrays when securing the endplate directly to the thermal exchange plate.

17. The securing method of claim 11, wherein the first and second arrays are side oriented arrays.

18. The securing method of claim 11, further comprising communicating thermal energy through respective bottom faces of the battery cells within the first and second arrays, and further comprising communicating electrical power to and from the battery cells through terminals disposed within another surface of the battery cells that is opposite the bottom surface.

19. The securing method of claim 11, further comprising communicating a fluid to the thermal exchange plate, from the thermal exchange plate, or both through an aperture provided within the thermal exchange plate.

20. The securing method of claim 11, further comprising, after the securing, repositioning the first and second arrays, and the thermal exchange plate, by interfacing with a handle member of the endplate.
